(19) United States
(12) Patent Application Publication
(10) Pub. No.: US 2004/0256441 A1
(43) Pub. Date: Dec. 23, 2004

(54) Shock wave consolidation of materials

(76) Inventors: Bernard Serole, Peyrins (FR); Michelle Serole, Peyrins (FR)

Correspondence Address: MCGLEW & TUTTLE, PC, 1 SCARBOROUGH STATION PLAZA, SCARBOROUGH, NY, 10510-0827, US

(21) Appl. No.: 10/495,272

(22) PCT Filed: Nov. 19, 2002
(86) PCT No.: PCT/EP02/12942

(30) Foreign Application Priority Data
Nov. 19, 2001 (FR) 01/14901

(51) Int. Cl. B23K 31/02

(52) U.S. Cl. 228/115

(57) ABSTRACT

A composite structure comprises several layers of various materials which are to be united by welding and simultaneously consolidated. The method resides in that the densities and moduli of elasticity of the various layers are adapted by composition, shape, state and temperature in such a way that the velocity of sound is considerably modified upon penetration of the composite structure. A shock wave is applied to one or both sides. This shock wave breaks down into harmonic vibrations that can sum up, concentration of energy resulting on the respective interfaces, ensuring the union within and between the layers.

The field of application of the present invention resides substantially in the production of structural components from metal, alloys, ceramics-metal composite materials or hard materials, in which the utensil, proceeding from powder, is solidified and consists of several layers of varying composition, thickness and properties. Lots of examples of triplex plates are known, in which a plate with certain properties is comprised between two resistant plates. Insulating material between two metal plates, a uranium alloy between two plates of an aluminum or zirconium alloy, a honeycomb structure between two metal plates can be cited by way of example. In certain cases the exterior plates insulate and protect an active core, in other cases the component possesses properties that are improved by the union, for example the moment of inertia in the case of the honeycomb structure.

The exterior plates may either have the same or a differing strength. The plates, which are exposed to mechanical stress or shocks, can be stronger. It can be said that plates intended for the inside of a container consist of metal or an alloy of good corrosion resistance or are suitable for food contact applications, whereas the exterior plate consists of an alloy which is more resistant mechanically.

One side could consist of copper, ensuring good cooling, and the other of AG5 for higher resistance and excellent behaviour in a marine atmosphere. AG5 is a classic alloy of aluminum and 5 percent by weight of magnesium. More than three layers can be provided, but there may just as well be only two layers when a structure is needed that is welded on a conductible component which consists of copper or is resistant, or which may consist of steel or Inconel or, in special cases, of titanium or a titanium alloy. Electric contacts and coating material for cathode or arc sputtering can be cited by way of example.

In the method according to the invention, the core, which may constitute any of the various layers, is a powder which is not initially pre-formed and which consolidates in the course of the same process and may be plated by the encapsulating material. After the process, the said capsule is effectively tightly united with the core, or it can split off by itself if its function is only temporary.

Background of the art: the basic manufacturing technology of powder-metallurgical parts can be summarized, taken in conjunction with a pressed steel compact. The tools include a die, a lower punch and an upper punch. The powder is poured into a die. The upper punch moves downwards, acting on the powder by a pressure of 50 kg/mm². The upper punch moves upwards again and ejects the compacted structure which is sufficiently solidified so that the preformed structure can be worked. Its relative density is approximately 85 percent. The compact is sintered in a hydrogen furnace by reducing atmosphere or by vacuum, obtaining a density of more than 95 percent. The compact is pressed into a die which calibrates it and compresses and smoothes the outside layer.

There are numerous variants of this basic technology dating back to around 1940. They mainly use hot pressing and hot isostatic pressing (HIP), enabling a great variety of quality components to be produced.

U.S. Pat. No. 5,397,050 of Tosoh SMD Inc. comprises an improvement in which a diffusion seal to a plate is to be accomplished at the same time as the consolidation of the powder. The titanium plate is placed on the bottom 5 of a vessel, the powder is poured thereon, compacted by the aid of a press and the vessel is closed. Then the container is put into a hot isostatic press, and a pressure of 1000 bar is applied at a temperature of approximately 1000° C. The process of hot isostatic pressing can be as follows: 1 hour of temperature and pressure increase, 4 hours of arrest and 4 hours of cooling and decompression. The seal between the solidified powder and the plate is obtained by solid-to-solid diffusion.

U.S. Pat. No. 6,248,291 of Asahi Glass Cy Ltd. defines a range of temperatures necessary for the accomplishment of a relative density of 95 percent in a powder mix. If for instance the constituent with the lowest melting point is aluminum which melts at 660° C., the required temperature during compression undershoots the melting point by at least 50° C., which corresponds to approximately 95 percent of the temperature in degrees centigrade.

A variant used for novel materials is described in Metals Handbook of ASM, 8^{th} edition, vol. 14, on pages 188 following. The method is called powder forging (P/F). As for the pressed steel compact described above, powder is compressed for the production of a preform, as in the basic method of production, but then calibrated or compacted by a shock. In the example mentioned, the preform, in a hot state, is placed into a die between two punches and pressed into the die by the shock, filling the entire free space in the die. This variant successfully works with a shock wave, but does not offer the possibility of plating.

EP 0 243 995 B1 specifies a way of producing target materials in two steps, in which a powder mix is first cold-pressed into a formed piece of approximately 90 percent of its theoretical density and then compacted, with or without protective cover, by repeated forming preferably in hydraulic forging presses. Owing to the need of production of a preform and the repeated forming jobs, this method is rather costly and does not offer the possibility of plating.

The article, “Impact Forging of Sintered Steel Preforms”, of A. A. Hendrickson et al., published in the magazine Powder Metallurgy, 2000, vol. 43, no. 4, mentions interesting details about powder forging technology and explains the term shock wave. The rates achieved by the machines used are explained.

| | | |
|---|---|---|
| Hydraulic press | 0.01 to 0.05 | m/s |
| Mechanical press | 0.02 to 0.6 | m/s |
| Screw press | 0.5 to 1 | m/s |
| Hammer | 4 to 7 | m/s |
| Petro-forge hammer | 9 to 18 | m/s |

The petro-forge hammer and similar machines achieve a tool rate of maximally 20 m/s according to Miller '81.

There is only a single way of engineering that offers the possibility of consolidating a powder and plating it in the same process, this being the explosion technology.

U.S. Pat. No. 5,779,852 of the Korean Institute for Machines & Materials teaches to use explosive matter, the explosion being sparked by an igniter which exposes the combination of powder and cover to a shock wave of a velocity of 2000 to 3000 m/s at a pressure of 1 to 30 Gpa, which corresponds to 100 to 3000 kg/mm².

U.S. Pat. No. 4,713,871 of Nippon Oil & Fats Co. Ltd. specifies a pressure of 10 Gpa to 100 Gpa in the case of the same technology, which corresponds to 1000 kg/mm² to 10,000 kg/mm².

DE 2 198 686 A of Kernforschungsanlage Jülich GmbH, using the same technology, specifies vacuum or controlled-atmosphere execution of the method. Presently, lots of soldered parts are known, in which the active part, either the honeycomb structure or the electric contact, is soldered against or between copper, aluminum, steel, Inconel.

The most common examples are known by the name “Al-clad”. The middle plate is comprised between two plates, which helps achieve an improved appearance and/or higher resistance. To this end, the classic method resides in piling three aluminum or aluminum alloy blocks one on top of the other, to join them by their sides by tacking or welding and to unite them by rolling at a high temperature. The rolling job will compact and extend them and reduce their thickness. Plating takes place separately from solidifying.

Principle of the invention: the shock wave is attributed to a shock. The present invention enables parts that may be comprised of several materials of varying thicknesses to be produced, forged or even rolled.

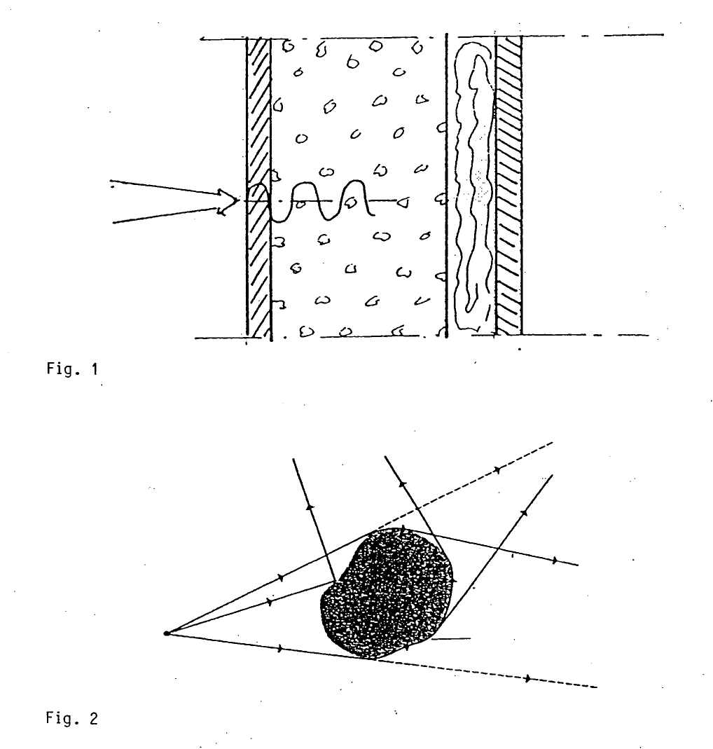

The principle consists in producing a combination of the joining elements in the form of superimposed or concentric layers. These layers may include a first plate which serves as an outside plated layer; a second plate for the core; a third plate as an intermediate layer; and a fourth plate for the second plated layer. FIG. 1 illustrates a container which is comprised of these layers and which is ready for the shock wave produced by the shock. These layers are used in such a way that they may strongly differ in thickness and mechanical properties.

A shock is applied at a high velocity to one side or to both sides, producing a shock wave in the composite structure. The velocity may range between 7 m/s and 100 m/s. Ideally, it ranges between 20 m/s and 60 m/s. This shock wave propagates in the material at a velocity that corresponds approximately to the sound velocity in the said material. The velocity of the shock wave changes upon penetration of each of the individual materials. The wave is deviated in soft material and reflected in solid material. FIG. 2 shows some possibilities of elementary behavior of a shock wave on the interface between two materials of different hardness. Summation of the shock waves takes place in the contact areas, which multiplies the energy, accomplishing a consolidation and union of by far higher quality than obtained by familiar forging, rolling or explosion welding.

As described above, the wave that propagates in the composite structure is displaced when penetrating the powder, the plastic layer and the hard layer. Each time the wave changes its velocity. Consequently, the method leads to superimposition of the waves. This principle of superimposition has considerable effects that can be calculated or are at least foreseeable.

For combining two waves, it is in fact sufficient to sum them up. The other way round, it is sufficient for the analysis of a wave to decompose it into a summation of elementary waves. Thus the theorem of Fourier is expressed as follows: on condition of regularity, each function F(t) of a real variable t can be decomposed into a sum of harmonic functions of the variable t, which means into one of the following sums of functions:

$$An cos WVnt + Bn cos WVnt$$

$$F ( t ) = {\sum }_{n} Cn exp i ( Wnt + An )$$

or:

$$F ( t ) = {\sum }_{n} An cos Wnt + Bn sin Wnt$$

$$F ( t ) = {\int }_{- ∞}^{∞} C ( ( ⅈw ) exp ⅈ wt ⅆ w$$

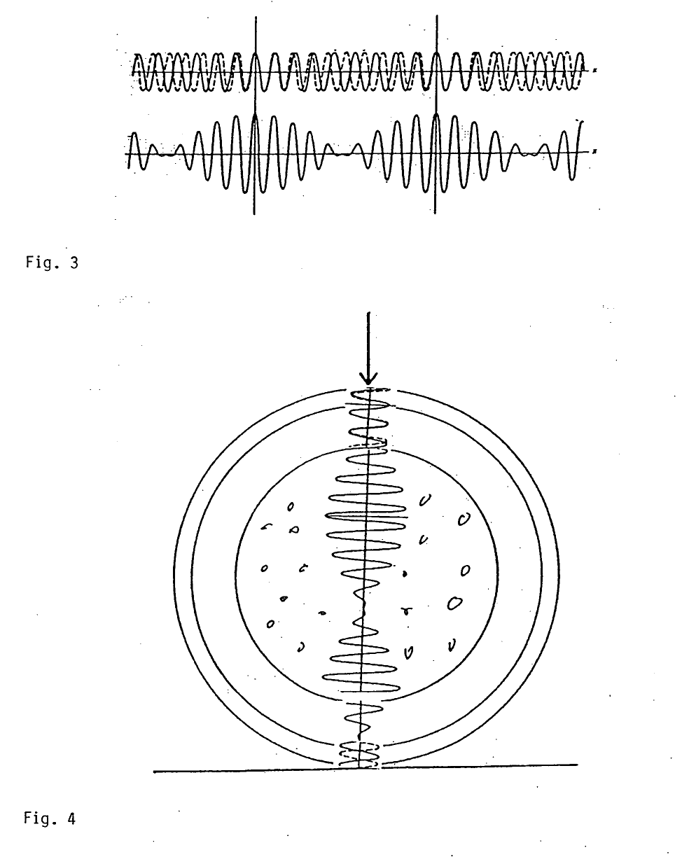

Each elementary function or Fourier component is characterized by its degree of development with respect to t. This sum indicates the superimposition of the harmonic waves as seen in FIG. 3.

The fact of the principle of superimposition of shock waves from a single shock can be explained by the varying velocities of sound in the materials in dependence on their structure and mechanical properties. The velocity of sound in water is approximately 1570 m/s, it is approximately 3000 m/s in most solids, but may vary between 1000 and 6000 m/s. The velocity of sound in steel is approximately 5000 m/s. In copper of a solid state it can be in the range of approximately 1000 m/s. Consequently, the materials themselves, their state and temperature will offer sufficient elbowroom for the method according to the invention to be put into practice on an industrial base.

On the other hand, the reduction of intensity of a spheric wave can be calculated based on the distance from its origin. In reality, the factual measurements never correspond to the results of computation. For this loss of intensity takes place even when the wave propagates in a homogeneous medium. This loss of intensity must be attributed to absorption and conversion into heat. One reason is the inner friction in the material. This friction is largely produced on the interface between two materials, powder grains-power grains interface, plate-grains interface, plate-plate interface . . . . Temperature peaks occur at the maximal compression planes. This temperature is transmitted to the adjacent planes. On the microscopic scale, the energy of the wave not only serves for increase of the translatory velocity of the atoms or molecules, but part of it gets lost, owing to collisions in the form of vibrations.

The velocity of the shock wave rises with increasing frequency. Therefore, it is of interest to produce the shock wave by shock application to a solid and thin layer of increased sound velocity, for example steel, Inconel, titanium.

The powder, granulate or the plastic layers, such as copper or aluminum at increased temperatures, must be arranged behind the hard layer. The reflecting layer must also be hard for absorption of the wave to be prevented, which would again result in the conditions of simple forging.

Origin of the shock wave: Let us have a look at a heavy mass such as a hammer or a forging die moving at a rate of 40 m/s. A shock is applied by the die to a container or bar on a firm support of high inertia. The bar includes several layers of different materials as seen in FIG. 1. The layer of a relative density of less than 1 i.e., the second layer, can be formed to have a thickness of 2 mm. The time needed for stopping the moving mass amounts to 1/10,000 seconds. This pulse produces a shock wave. With the moved mass having a weight of 30 tons, the work applied to the bar can be computed as follows:

$$W = 1 / 2 \cdot ( 30 , 000 / 9.81 ) {V}^{2} .$$

With the speed being 40 m/s, the result is

W=2446 mt.

These speeds are attained under certain circumstances with machines operated by compressed air or steam. In the case of steam, negative side effects are occasioned by flash vaporization. A forming machine with two counterblow dies of identical rate has the advantage that pieces can be produced without any difference between top and bottom side.

Time interval of the shock: The time interval of the shock does not primarily depend on the rate of the die, but only on the mass that delivers the shock and the flexibility of the structure that takes the shock, consequently on the density and modulus of elasticity of the composite structure. For example, the modulus of elasticity of a copper aluminum alloy at ambient temperature is 6500 kg/mm², while the modulus of steel is 22,000 kg/mm².

The time interval of the shock can be expressed as follows:

$$t = ( 3 \cdot π \cdot L ) \cdot \sqrt{\frac{3 \cdot D}{1000 \cdot M \cdot g}}$$

with L being the thickness of the structural component,

M the modulus of elasticity in kg/mm²,

D the density.

Propagation of the shock wave: The velocity of propagation of the shock wave virtually corresponds to the sound velocity in the material.

In composite structures with at least one of the materials being comparatively soft due to increased temperature or low relative density, it can be assumed that rebound does not occur and that the insignificant shock interval corresponds to a first and single shock wave.

Load acting on the structural component: The load that acts on the component at the beginning constitutes the first phase of working as is the case with other methods and as applied by a classic hammer, a hydraulic or mechanical press or even a hot isostatic press. This working is superimposed by the working that is specifically performed by the shock wave.

Some studies refer to the following formula:

$$R = V \cdot \sqrt{\frac{3 \cdot D \cdot M}{1000 \cdot g}}$$

with V being the velocity,

M the modulus of elasticity in kg/m²,

d the density,

g 9.81 m/s²,

R the specific load in kg/mm².

This load is 35 kg/mm² when the material is being compacted, resulting in a load of 25,000 tons for a bar of 1200×600 mm of surface.

Shock load and wave: The load by itself has a familiar effect. It can be applied by a press or a classic forging machine.

Within the scope of the invention, the load by which the material is compacted serves as a basis. From a certain velocity onwards with accurate arrangement of the composite structure being kept, a shock wave is produced that penetrates the material, is reflected and refracted, thus concentrating on the selected interfaces. This velocity, together with the corresponding arrangement, form part of the invention.

Interfaces: The wave propagates at a high velocity in the hard layers and at a low velocity in the soft layers and is refracted at certain hard spots.

Method according to the invention: The method within the scope of the invention is as follows. A piece of a pipe is cut, cleaned and closed by welding at one end. Then it is filled with metal powder and closed under vacuum at the other end. This is the classic procedure. The pipe is heated to a temperature that corresponds to approximately half the melting temperature of the powder. The pipe is placed on a block of hardened steel or on a similar hard tool and a shock is applied, which is produced by another block and propagates at an adapted velocity between 20 and 60 m/s. The powder is consolidated, having a density that exceeds 96 percent and the union with the pipe is of metallurgical quality.

The method is defined even more precisely by the following conditions. The container pipe is the optional plated layer.

The powder is not inserted as a preform into the container. Evidently, the present method enables high density materials to be produced without the additional step of preform fabrication.

The shock is delivered by mechanical means without explosion.

The method does not make use of tools which comprise a die with a punch or a closed die.

The dies are flat, having a relative rate in the range of 7 m/sec to 100 m/sec, ideally of between 20 m/s and 60 m/s.

The sound velocities in the various structures, the plated layer, core, and possibly further constituents, have a ratio of at least 1:2 or more under working conditions.

The method is put into practice at a temperature that is lower than customary forging, sintering or rolling temperatures, which corresponds to a temperature of 40 to 80 percent of the melting point in degrees centigrade as opposed to normally 80 to 95 percent. In any case, the temperatures are below the melting temperature of the component that has the lowest melting point.

In the simplest of cases the powder is for example chromium metal powder.

In a first variant, the powder is a mix of several metal powders, for example Ti and Al, or Cr and Ni, or Mo, Cr and Si (nonmetal). The number is not fixed, it is only necessary to obtain a homogeneous mix. In practice, the inventor has rarely exceeded a number of six constituents in the case of cobalt-based alloys.

In a second variant, the powder is a mix of metal and ceramic powders, such as Ti and TiB₂, or Cr and Cr₂O₃.

In a third variant, the pipe consists of metal or another alloy, for example on a copper, titanium, Inconel or aluminum base.

In a fourth variant, the pipe is not round, but ellipsoidal or rectangular.

In a fifth variant, the required pipe of copper or aluminum is too soft, there being no possibility of ensuring a controlled shape after the action. It is therefore placed into a stabilizing container or an exterior pipe for example of stainless steel (FIG. 4.).

In a sixth variant, the pipe is dimensioned such that the working will not be sufficient for simultaneous consolidation and union i.e., a load of not more than 1 to 5 kg/mm² is applied. The union obtained only serves as an initial material for consolidation and union by rolling, and replaces, by micro-range adhesion, any welding or folding of edges, this ensuring homogeneous velocity between the layers for shearing of the linkages during the individual rolling passes to be avoided.

### FIRST EXAMPLE OF INDUSTRIAL APPLICATION

A container comprising a stainless steel pipe of a length of one meter, a diameter of 140 mm and a thickness of 5 mm is provided with a layer of copper on the inside. This layer constitutes an interior pipe of an initial thickness of 10 mm. The composite pipe produced is closed by welding at one end and then filled with a mix of titanium and aluminum powders which need not be compressed or inserted in any other form as is the case with a preform used in powder forging. The composite structure is heated to a temperature that may be clearly lower than the melting temperature of the structure of lowest melting temperature, which is the aluminum in the present case, i.e. lower by more than 100° C., and a shock is delivered by two opposed flat bodies at a rate of approximately 28 m/s. At this temperature, the layer of stainless steel has a modulus of elasticity of 17,000, loose powder and copper of approximately 2,000. The load applied compacts the powder by approximately 90 percent, which might take place by a hydraulic press of moderate capacity. The shock wave penetrates the steel without changing the initial properties thereof, it penetrates the compressed powder by considerable scattering and is refracted in the copper. It is stopped by the second steel layer and reflected. The shock wave concentrates on the part that is to be applied by plating, where it works mechanically and releases heat. After this process, the powder mix is consolidated and united with the copper by welding. Thus a duplex plate is obtained by machine working. The steel only serves as a transmitter and protective cover. The mechanical useful load, which is applied only for a short interval of less than 1/10 s, can be in the range of some kg/mm². Nevertheless the powder is entirely consolidated and plating is ensured by a genuine metallurgical connection.

### SECOND EXAMPLE OF INDUSTRIAL APPLICATION

A container comprising a stainless steel pipe of a thickness of 4 mm is filled with chromium powder and closed at both ends under vacuum. The cylindrical sleeve of steel of an initially round cross-sectional shape is flattened prior to being filled, the cross-sectional shape then being elliptical. The composite pipe is heated to a temperature that may be half the melting temperature of chromium, and then a shock is applied by two bodies that approach each other at a rate of approximately 25 m/s. The shock wave is refracted by the chromium grains and reflected, concentration of energy and summation of the wave on the chromium-steel interface being occasioned. Electronic microscopy shows that the chromium grains and the steel are welded together. If torsion is applied, the structure will not fracture at the interface, but in the vicinity of the chromium. In spite of low mechanical load for a very short time, the powder consolidates and plating is ensured.

### THIRD EXAMPLE OF INDUSTRIAL APPLICATION

A bar comprises two plates of an aluminum alloy which are separated by a layer of a powder mix on the basis of an aluminum alloy. It has no especially high relative density; consequently it is not a preform. The composite structure is kept together by a welded frame of an aluminum alloy or, in another case, it is placed into a container of stainless steel. The composition is closed under the action of vacuum. The bar is heated to a mean temperature which is by 200° C. lower than the melting temperature of the aluminum and subjected to a shock of two bodies in motion at a rate of approximately 28 m/s. The powder is compressed to a density of approximately 85 percent by the action of the load. Consolidation of the powder and its being welded to the central part, originally of powder, takes place by way of the two lateral plates or the sleeve by refraction and summation of the shock wave. The welded union of core and sleeve is sufficiently strong so that simultaneous rolling of the bar can be performed without the components moving.

### FURTHER EXAMPLES OF INDUSTRIAL APPLICATIONS

In addition to the constituents of the three examples mentioned above, it has been found that the method can be successfully applied to the following pairs of material: chromium-copper in spite of the temperature of less than 1000° C. and approximately 50 percent of the melting temperature of chromium in degrees centigrade which is determined by the behavior of copper; chromium-Inconel; titanium-aluminum; titanium-titanium diboride which is a ceramic material—stainless steel; nickel chromium alloys—steel and Inconel; zircon alloy-uranium alloy-zircon alloy, the same with aluminum-based plating. The method is flexible in that solid material can be inserted in the form of powder, which reduces the velocity of propagation of the wave.

For presentation of the efficiency of the mentioned method, it has been ensured that the method works for a number of materials such as chromium, titanium aluminum, titanium diboride with plated layers of steel, copper, aluminum, titanium or titanium alloys. Systematic tests on real structural components have shown that the mentioned method will attain excellent results even with non-metal and ceramic constituents. In this case, a layer consists of at least a powder or a sub-alloy of the materials Al, C, Si, Ti, Cr, Mn, Fe, Co, Ni, Cu, Zn, Nb, Mo, Bi, Ce, V, Zr, Ta, W, Al₂O₃, ZnO, TiB₂, MoS₂, TiC, SiAl as well as one or several layers of solid metal.

The method can be employed as described above, however there is also the possibility, if one or several sleeves are not to be kept in the final product, to remove them by working, in order only to use the core and one or several layers of the sleeve. In this case, the sleeve only has a temporary function during the manufacturing process. For expensive mechanical treatment to be avoided, a method can be applied in which the removal of the sleeve needs not be effected by costly working. In this case a wash which works, among other things, as a diffusion barrier is applied to one constituent or several constituents, for example on the inside of a stainless steel pipe. This thin layer of some micrometers does not interact upon propagation of the shock wave, enabling the sleeve to be removed easily, which would be jeopardized by diffusion. Various layers, mainly oxidic and non-oxidic ceramics, have been successfully tested to this end.

1. A method of consolidating and simultaneously uniting metallic or ceramic materials in several heterogeneous layers by a shock wave, wherein intensification of the shock wave takes place by concerted reflection, refraction and concentration on the interfaces, owing to varying velocities of propagation in the various layers.

2. A method according to claim 1, wherein the shock wave is produced by a mechanical shock by a flat hard tool on the material that is to be worked.

3. A method according to claim 1, wherein the shock wave is produced by the shock, on the structural component, of a mass that is moved at a corresponding rate between 7 m/sec and 100 m/sec, preferably 20 m/s to 60 m/s.

4. A method according to claim 1, wherein the sound transmission velocity in the various layers is in the ratio of 1:2 or more.

5. A method according to claim 1, wherein one layer consists of powder and at least one layer of solid metal.

6. A method according to claim 1, wherein one layer consists of finely powdered chromium and the other layer of stainless steel.

7. A method according to 1, wherein the one layer is a titanium aluminum mix or alloy and the other layer consists of stainless steel.

8. A method according to claim 1, wherein the one layer consists of powder which contains titanium diboride and the other layer consists of stainless steel.

9. A method according to claim 1, wherein modification of the successive velocities of the shock wave is attained by a core that consists of a soft layer and is enveloped by two intermediate layers of varying hardness, these layers again being enveloped by two exterior layers that are even harder than the three layers mentioned above.

10. A method according to claim 9, wherein the one layer consists of titanium aluminum and the intermediate layer of copper.

11. A method according to claim 9, wherein the one layer consists of chromium and the intermediate layer of copper.

12. A method according to claim 9, wherein the one layer contains titanium diboride and the intermediate layer consists of copper.

13. A method according to claim 1, wherein at least one layer consists of at least one of a powder and of at least one sub-alloy of the following materials: Al, C, Si, Ti, Cr, Mn, Fe, Co, Ni, Cu, Zn, Nb, Mo, Bi, Ce, V, Zr, Ta, W. Al₂O₃, ZnO, TiB₂, MoS₂, TiC, SiAl, as well as one or several layers of solid metal.

14. A method according to claim 1, wherein at least one layer serves solely as a protective cover and needs not belong to the actual structural component.

15. A method according to claim 1, wherein consolidation and union are supported by temperatures below the melting temperature of the constituent with the lowest melting point.

16. A method according to claim 1, wherein the method is used for producing encapsulated input material for a plating process, and is no longer used as an independent method, so that the union can be directly effected by forging.
